(19) United States
(12) Patent Application Publication
(10) Pub. No.: US 2026/0350669 A1
(43) Pub. Date: Nov. 5, 2026

(54) Sealed Inventory Verification and Real-Time Offer Control Within Platform Execution Rails

(71) Applicant: ADRIAN FARIAS JARAMILLO, JURUPA VALLEY, CA (US)

(72) Inventor: ADRIAN FARIAS JARAMILLO, JURUPA VALLEY, CA (US)

(21) Appl. No.: 19/336,024

(22) Filed: Sep. 22, 2025

Related U.S. Application Data
(63) Continuation of application No. 19/197,894, filed on May 2, 2025.
(60) Provisional application No. 63/786,937, filed on Apr. 10, 2025.
(60) Provisional application No. 63/787,944, filed on Apr. 13, 2025.
(60) Provisional application No. 63/788,834, filed on Apr. 15, 2025.
(60) Provisional application No. 63/791,534, filed on Apr. 20, 2025.
(60) Provisional application No. 63/792,918, filed on Apr. 23, 2025.

(51) Int. Cl. G06Q 30/0601; G06Q 10/083

(52) U.S. Cl. CPC G06Q 30/0611; G06Q 10/083

(57) ABSTRACT

A system for verifying and controlling inventory-linked offer availability on a platform through a sealed execution rail. The system ensures that only verified, trust-compliant inventory may be linked to buyer-facing offers. Third-party sync tools are blocked unless licensed. Offers are revoked when inventory is unverified or depleted, enforcing sealed commercial integrity.

### CROSS-REFERENCE TO RELATED APPLICATIONS

This application is a continuation of U.S. Utility patent application Ser. No. 19/197,894, filed May 2, 2025, which claims the benefit of the following U.S. Provisional Patent Applications, each of which is incorporated herein by reference in its entirety:
U.S. Provisional Application No. 63/786,937, filed Apr. 10, 2025, titled “System and Method for Buyer-Initiated Marketplace Transactions Across Multiple Industries”
U.S. Provisional Application No. 63/787,944, filed Apr. 13, 2025, titled “Sealed Toolset and Logic Framework for Buyer-Initiated Offer Systems”
U.S. Provisional Application No. 63/788,834, filed Apr. 15, 2025, titled “Toolset Protection for Modular Buyer-Initiated Offer Ecosystem”
U.S. Provisional Application No. 63/791,534, filed Apr. 20, 2025, titled “Modular Toolset Architecture for Multi-Sector Buyer-Initiated Commerce Infrastructure”
U.S. Provisional Application No. 63/792,918, filed Apr. 23, 2025, titled “Lockdown: Final Enforcement Tools for Global Buyer-Initiated Transaction Control”

### FIELD OF THE INVENTION

The present invention relates to digital commerce platforms, and more specifically to systems and methods for verifying inventory status and controlling real-time offer presentation within sealed execution rails.

### BACKGROUND OF THE INVENTION

Conventional e-commerce systems often rely on third-party inventory sync tools, API plugins, or manual updates that are disconnected from trusted fulfillment logic.

This disconnect enables sellers to present outdated or false inventory data, leading to unreliable order execution and consumer risk.

There is a need for a platform-native system that locks inventory verification and offer availability within a sealed, trust-verified rail.

### SUMMARY OF THE INVENTION

The disclosed system ensures that all inventory data linked to offer availability is verified through a platform-licensed and escrow-compatible rail.

Sellers may only present offers if real-time inventory checks pass trust thresholds and licensing requirements.

External sync tools are blocked unless authorized and embedded via the platform's execution framework.

Inventory status is logged, monitored, and tethered to metadata identifiers for compliance and enforcement.

### DETAILED DESCRIPTION OF THE INVENTION

The invention includes an inventory verification module that resides natively within the platform or is embedded through licensed APIs.

All inventory data is timestamped, logged, and tethered to seller ID, license status, and metadata profile.

Offer triggers initiated by buyers are cross-referenced against verified inventory at the time of request.

Offers cannot be displayed if inventory verification fails or is outdated.

The system blocks external tools that attempt to update or display inventory without sealed integration.

Compliance logic includes geographic restrictions, fulfillment capability checks, and fraud indicators.

Each inventory record is stored in a platform-controlled ledger that matches trust tiers and licensing status.

When inventory is depleted, all associated offers are revoked until reverified.

The system prevents spoofing of inventory levels via third-party scripts or plugin injection.

Platform enforcement modules monitor activity and flag anomalies tied to inventory-related offer attempts.

All inventory-linked fulfillment must route through escrow logic, ensuring delivery compliance.

What is claimed is:

1. A system comprising:
an inventory verification module embedded within a digital commerce platform;
a sealed execution controller;
and a real-time offer engine that prevents presentation of offers unless inventory is verified.

2. The system of claim 1, wherein the inventory verification module cross-references seller ID, trust score, license status, and product metadata.

3. The system of claim 1, wherein the sealed execution controller blocks offer presentation upon inventory depletion or verification failure.

4. A method comprising:
receiving buyer request input;
initiating an inventory verification process;
and generating an offer only if inventory is cleared and escrow-compatible.

5. The system of claim 1, wherein inventory data must be updated through a platform-licensed tool or API.

6. The method of claim 4, further comprising rejecting any offer attempt if inventory metadata is mismatched or stale.

7. A system comprising:
a ledger of verified inventory records;
metadata logging tools;
and an enforcement engine that disables offers tied to expired inventory entries.

8. The system of claim 1, wherein third-party plugins attempting inventory sync are rejected unless platform-authorized.

9. A method comprising:
associating inventory status with license tier and jurisdictional permissions before enabling offer presentation.

10. The system of claim 1, further comprising: a geographic compliance checker that disables offers not permitted by location.

11. A sealed offer routing method comprising:
inventory status check;
escrow lock activation;
and trust-tier validation before offer visibility.

12. The system of claim 1, wherein inventory data is automatically logged with timestamp and vendor fingerprint.

13. A method comprising:
revoking all outstanding offers once inventory falls below minimum verified threshold.

14. The system of claim 1, wherein compliance modules detect and log attempts to spoof or fabricate inventory.

15. A method comprising:
matching inventory to a fulfillment capability registry before offer approval.

16. A platform-native offer control engine that dynamically adjusts visibility based on live inventory verification.

17. The system of claim 1, wherein each inventory entry must carry escrow compatibility and metadata traceability.

18. The method of claim 4, wherein seller dashboards are restricted from displaying offers tied to unverified stock.

19. A system comprising:
a platform-controlled offer engine, inventory sync control logic, and rejection triggers for non-verified stock data.

20. The system of claim 1, further comprising: an enforcement suite that flags seller accounts attempting to bypass inventory validation.

21. The system of claim 1, wherein fulfillment is deferred until payment rails confirm sealed execution compliance via escrow timestamp validation.
